(19) United States
(12) Patent Application Publication
(10) Pub. No.: US 2026/0266183 A1
(43) Pub. Date: Sep. 10, 2026

(54) TURBINE ENGINE VANE BAFFLE

(71) Applicant: RTX Corporation, Farmington, CT (US)

(72) Inventors: Russell J. Bergman, South Windsor, CT (US); Scott A. Kovach, Higganum, CT (US); Jaime G. Ghigliotty Rosado, Cabo Rojo, PR (US); Efrain Vega Rios, Manati, PR (US); Dominic J. Mongillo, Jr., West Hartford, CT (US)

(21) Appl. No.: 19/073,816

(22) Filed: Mar. 7, 2025

(51) Int. Cl. F01D 5/18; F01D 25/12

(52) U.S. Cl. CPC F01D 5/18; F01D 25/12; F05D 2220/323; F05D 2260/232

(57) ABSTRACT

A turbine engine assembly includes an airfoil and a baffle. The baffle is disposed in an airfoil cavity with an outer passage formed between the baffle and a wall of the airfoil. The baffle extends longitudinally from a baffle end to a baffle trailing edge. The baffle extends laterally between a baffle first side and a baffle second side with the baffle second side meeting the baffle first side at the baffle trailing edge. The baffle includes an endwall, a first sidewall, a second sidewall and a baffle cavity. The endwall forms the baffle end laterally along the baffle cavity. The first sidewall forms the baffle first side longitudinally along the baffle cavity. The second sidewall forms the baffle second side longitudinally along the baffle cavity. The second sidewall is bonded to the first sidewall at the baffle trailing edge.

### GOVERNMENT LICENSE RIGHTS

This invention was made with Government support under Contract N00019-21-G-0005; DO N00019-23-F-0019 awarded by the United States Navy. The Government has certain rights in this invention.

### BACKGROUND OF THE DISCLOSURE

### 1. Technical Field

This disclosure relates generally to a turbine engine and, more particularly, to a turbine vane structure for the turbine engine.

### 2. Background Information

A gas turbine engine such as a turbofan engine may include multiple vane structures within its turbine section. Various types and configurations of turbine section vane structures are known in the art. While these known turbine section vane structures have various benefits, there is still room in the art for improvement.

### SUMMARY OF THE DISCLOSURE

According to an aspect of the present disclosure, an assembly is provided for a turbine engine. This assembly includes an airfoil and a baffle. The airfoil extends spanwise from an airfoil base end to an airfoil tip end. The airfoil extends longitudinally from an airfoil leading edge to an airfoil trailing edge. The airfoil extends laterally between an airfoil first side and an airfoil second side with the airfoil second side meeting the airfoil first side at the airfoil leading edge and the airfoil trailing edge. An airfoil cavity projects spanwise into the airfoil from the airfoil tip end towards the airfoil base end. The baffle is disposed in the airfoil cavity with an outer passage formed between the baffle and a wall of the airfoil. The baffle extends longitudinally from a baffle end to a baffle trailing edge. The baffle extends laterally between a baffle first side and a baffle second side with the baffle second side meeting the baffle first side at the baffle trailing edge. The baffle includes an endwall, a first sidewall, a second sidewall and a baffle cavity. The endwall forms the baffle end laterally along the baffle cavity. The first sidewall forms the baffle first side longitudinally along the baffle cavity. The second sidewall forms the baffle second side longitudinally along the baffle cavity. The second sidewall is bonded to the first sidewall at the baffle trailing edge.

According to another aspect of the present disclosure, another assembly is provided for a turbine engine. This assembly includes at least one airfoil and a baffle. The airfoil extends spanwise from an airfoil base end to an airfoil tip end. The airfoil extends longitudinally from an airfoil leading edge to an airfoil trailing edge. The airfoil extends laterally between an airfoil first side and an airfoil second side with the airfoil second side meeting the airfoil first side at the airfoil leading edge and the airfoil trailing edge. An airfoil cavity projects spanwise into the airfoil from the airfoil tip end towards the airfoil base end. The baffle is disposed in the airfoil cavity with a passage formed between the baffle and a wall of the airfoil. The baffle extends longitudinally from a baffle end to a baffle trailing edge. The baffle extends laterally between a baffle first side and a baffle second side with the baffle second side meeting the baffle first side at the baffle trailing edge. The baffle extends spanwise from a baffle base end to a baffle tip end. The baffle includes a first sidewall, a second sidewall and a baffle cavity. The first sidewall forms the baffle first side longitudinally along the baffle cavity. The second sidewall forms the baffle second side longitudinally along the baffle cavity. The first sidewall meets the second sidewall at an interface spanwise along the baffle trailing edge. The first sidewall longitudinally overlaps and laterally abuts against the second sidewall at the interface. The first sidewall is bonded to the second sidewall at the interface.

According to still another aspect of the present disclosure, another assembly is provided for a turbine engine. This assembly includes at least one airfoil and a baffle. The airfoil extends spanwise from an airfoil base end to an airfoil tip end. The airfoil extends longitudinally from an airfoil leading edge to an airfoil trailing edge. The airfoil extends laterally between an airfoil first side and an airfoil second side with the airfoil second side meeting the airfoil first side at the airfoil leading edge and the airfoil trailing edge. An airfoil cavity projects spanwise into the airfoil from the airfoil tip end towards the airfoil base end. The baffle is disposed in the airfoil cavity with a passage formed between the baffle and a wall of the airfoil. The baffle extends longitudinally from a baffle end to a baffle trailing edge. The baffle extends laterally between a baffle first side and a baffle second side with the baffle second side meeting the baffle first side at the baffle trailing edge. The baffle includes an endwall, a first sidewall, a second sidewall and a baffle cavity. The endwall forms the baffle end laterally along the baffle cavity. The first sidewall forms the baffle first side longitudinally along the baffle cavity. The second sidewall forms the baffle second side longitudinally along the baffle cavity. The first sidewall is bonded to the endwall at a corner between the baffle end and the baffle first side.

The baffle may also include an endwall forming the baffle end laterally along the baffle cavity. The first sidewall may be bonded to the endwall at a corner between the baffle end and the baffle first side.

The baffle cavity may extend laterally within the baffle from the first sidewall to the second sidewall. The baffle cavity may extend longitudinally within the baffle from the endwall to a lateral interface between the first sidewall and the second sidewall at the baffle trailing edge.

The first sidewall may extend longitudinally uninterrupted along the baffle cavity from the endwall to the lateral interface. In addition or alternatively, the second sidewall may extend longitudinally uninterrupted along the baffle cavity from the endwall to the lateral interface.

The baffle may extend spanwise from a baffle base end disposed at the airfoil base end to a baffle tip end disposed at the airfoil tip end. The baffle cavity may be closed at the baffle base end.

The baffle may extend spanwise from a baffle base to a baffle tip. The second sidewall may be bonded to the first sidewall at the baffle trailing edge spanwise along the baffle trailing edge from the baffle base to the baffle tip.

At the baffle trailing edge, the first sidewall may extend longitudinally along and may be abutted laterally against the second sidewall.

The first sidewall and the second sidewall may extend longitudinally to a common location at the baffle trailing edge.

An edge of the first sidewall may be longitudinally recessed from an edge of the second sidewall at the baffle trailing edge.

The first sidewall may be welded to the second sidewall at the baffle trailing edge.

The first sidewall may be formed by a first sheet of metal. The endwall and the second sidewall may be formed by a second sheet of metal. The first sheet of metal may be bonded to the second sheet of metal at the baffle trailing edge.

The first sheet of metal may also be bonded to the second sheet of metal at a corner between the endwall and the first sidewall.

The airfoil first side may be a suction side of the airfoil. The baffle first side may be disposed laterally between the baffle second side and the airfoil first side. The airfoil second side may be a pressure side of the airfoil. The baffle second side may be disposed laterally between the baffle first side and the airfoil second side.

The airfoil first side may be a convex side of the airfoil. The baffle first side may be disposed laterally between the baffle second side and the airfoil first side. The airfoil second side may be a concave side of the airfoil. The baffle second side may be disposed laterally between the baffle first side and the airfoil second side.

The baffle may extend spanwise from a baffle base end to a baffle tip end. The baffle further may include a flange at the baffle tip end. The flange may project laterally out from one of the endwall, the first sidewall or the second sidewall.

The baffle may extend spanwise from a baffle base end to a baffle tip end. At least a portion of a centerline of the baffle cavity that extends spanwise from the baffle base end to the baffle tip end may be non-linear.

The assembly may also include a turbine vane structure including the airfoil and the baffle.

The assembly may also include an inner platform, an outer platform and a plurality of vanes. The inner platform may extend circumferentially around a centerline. The outer platform may extend circumferentially around the centerline. The vanes may be arranged circumferentially around the centerline in an array. Each of the vanes may extend spanwise from the inner platform to the outer platform. A first of the vanes may include at least the airfoil.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a partial schematic sectional illustration of an aircraft powerplant.

FIG. 2 is a partial sectional illustration of a turbine section engine assembly.

FIG. 3 is a schematic end view illustration of a turbine vane structure.

FIG. 4 is a partial side sectional illustration of the turbine vane structure mated with an inner air seal plate.

FIG. 5 is a sectional illustration of a turbine vane.

FIG. 6 is a side cutaway illustration of the turbine vane structure mated with the inner air seal plate.

FIG. 7 is a sectional illustration of an exemplary vane baffle.

FIG. 8 is a cross-sectional illustration of the vane baffle.

FIG. 9 is a partial sectional illustration of another vane baffle configuration.

FIGS. 10A-C are partial sectional illustrations of the vane baffle at an edge with various edge arrangements, and FIGS. 10D and 10E are sectional illustrations of the vane baffle with various other baffle and edge arrangements.

FIG. 11 is a side view illustration of the vane baffle.

FIGS. 12A and 12B are partial sectional illustrations of a baffle element with non-perforated and perforated arrangements.

FIGS. 13A and 13B are end view illustrations of the vane baffle with various flange arrangements.

FIGS. 14A-E are sectional illustrations of the vane baffle with alternative constructions.

### DETAILED DESCRIPTION

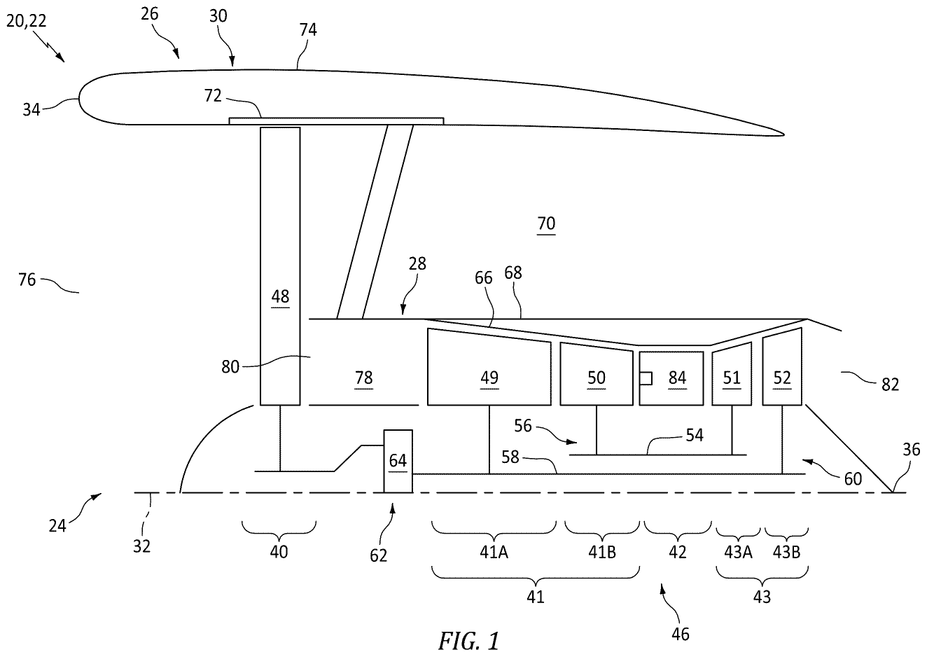

FIG. 1 illustrates a powerplant 20 for an aircraft. The aircraft may be an airplane, a drone (e.g., an unmanned aerial vehicle (UAV)) or any other manned or unmanned aerial vehicle or system. For ease of description, the aircraft powerplant 20 is described below as a propulsion system 22 for the aircraft and, more particularly, as a turbofan propulsion system. The aircraft powerplant 20 of the present disclosure, however, is not limited to such an exemplary propulsion system. The aircraft propulsion system 22, for example, may alternatively be configured as a turbojet propulsion system, a turboprop propulsion system, a turboshaft propulsion system, a propfan propulsion system, a pusher fan propulsion system, or any other type of ducted or open rotor propulsion system. Moreover, the aircraft powerplant 20 is not limited to propulsion system applications. The aircraft powerplant 20, for example, may alternatively (or also) be configured as an electrical power system for the aircraft (e.g., an auxiliary power unit (APU)) or a ground-based (e.g., industrial) electrical power system.

The aircraft propulsion system 22 includes a gas turbine engine 24 (e.g., a turbofan engine) housed within a stationary engine housing 26, which engine housing 26 of FIG. 1 includes an inner housing structure 28 and an outer housing structure 30. The aircraft propulsion system 22 extends axially along an axis 32 between an axial forward, upstream end 34 of the aircraft propulsion system 22 and an axial aft, downstream end 36 of the aircraft propulsion system 22. Briefly, the powerplant axis 32 may be a centerline axis of the aircraft propulsion system 22, the turbine engine 24 and/or one or more of its members. The powerplant axis 32 may also or alternatively be a rotational axis for one or more members of the turbine engine 24.

The aircraft propulsion system 22 and its turbine engine 24 of FIG. 1 includes a propulsor section 40 (e.g., a fan section), a compressor section 41, a combustor section 42 and a turbine section 43. The compressor section 41 of FIG. 1 includes a low pressure compressor (LPC) section 41A and a high pressure compressor (HPC) section 41B. The turbine section 43 of FIG. 1 includes a high pressure turbine (HPT) section 43A and a low pressure turbine (LPT) section 43B. Here, at least (or only) the LPC section 41A, the HPC section 41B, the combustor section 42, the HPT section 43A and the LPT section 43B collectively form a core 46 of the turbine engine 24.

The engine sections 40-43B may be arranged sequentially along the powerplant axis 32 within the engine housing 26. The propulsor section 40 includes a bladed propulsor rotor 48; e.g., a fan rotor. The LPC section 41A includes a bladed low pressure compressor (LPC) rotor 49. The HPC section 41B includes a bladed high pressure compressor (HPC) rotor 50. The HPT section 43A includes a bladed high pressure turbine (HPT) rotor 51. The LPT section 43B includes a bladed low pressure turbine (LPT) rotor 52.

The HPC rotor 50 is coupled to and rotatable with the HPT rotor 51. The HPC rotor 50 of FIG. 1, for example, is connected to the HPT rotor 51 through a high speed shaft 54. At least (or only) the HPC rotor 50, the HPT rotor 51 and the high speed shaft 54 collectively form a high speed rotating structure 56; e.g., a high speed spool of the engine core 46. This high speed rotating structure 56 of FIG. 1 and its members 50, 51 and 54 are rotatable about the powerplant axis 32.

The LPC rotor 49 is coupled to and rotatable with the LPT rotor 52. The LPC rotor 49 of FIG. 1, for example, is connected to the LPT rotor 52 through a low speed shaft 58. At least (or only) the LPC rotor 49, the LPT rotor 52 and the low speed shaft 58 collectively form a low speed rotating structure 60; e.g., a low speed spool of the engine core 46. This low speed rotating structure 60 is further coupled to the propulsor rotor 48 through a drivetrain 62. The drivetrain 62 may be configured as a geared drivetrain, where a geartrain 64 (e.g., a transmission, a speed change device, an epicyclic geartrain, etc.) is disposed between and operatively couples the propulsor rotor 48 to the low speed rotating structure 60 and its LPT rotor 52. With this arrangement, the propulsor rotor 48 may rotate at a different (e.g., slower) rotational speed than the low speed rotating structure 60 and its LPT rotor 52. Alternatively, the drivetrain 62 may be configured as a direct-drive drivetrain, where the geartrain 64 is omitted. With such an arrangement, the propulsor rotor 48 rotates at a common (the same) rotational speed as the low speed rotating structure 60 and its LPT rotor 52. The low speed rotating structure 60 of FIG. 1 and its members 49, 52 and 58 as well as the propulsor rotor 48 are rotatable about the powerplant axis 32. However, it is contemplated the low speed rotating structure 60 may alternatively be rotatable about another axis radially and/or angularly offset from the rotational axis of the propulsor rotor 48 and/or the centerline axis of the turbine engine 24.

The inner housing structure 28 of FIG. 1 includes an inner case 66 (e.g., a core case) for the turbine engine 24 and an inner nacelle structure 68 (sometimes referred to as an inner fixed structure (IFS)). The inner case 66 is disposed radially outboard of, extends axially along and may circumscribe one or more or all of the engine sections 41A-43B and their respective engine rotors 49-52. The inner case 66 may thereby house and provide a support structure for the respective engine sections 41A-43B and their respective engine rotors 49-52. The inner nacelle structure 68 is configured to provide an aerodynamic cover over the engine core 46 and its inner case 66. The inner housing structure 28 and its inner nacelle structure 68 may also form a radial inner peripheral boundary of a bypass flowpath 70 (e.g., an annular bypass flowpath) within the aircraft propulsion system 22.

The outer housing structure 30 of FIG. 1 includes an outer case 72 (e.g., a fan case) for the turbine engine 24 and an outer nacelle structure 74. The outer case 72 is disposed radially outboard of, extends axially along and may circumscribe the propulsor section 40 and its propulsor rotor 48. The outer case 72 may thereby house and provide a containment structure for the propulsor section 40 and its propulsor rotor 48. The outer nacelle structure 74 is configured to provide an aerodynamic cover over the outer case 72. The outer housing structure 30 and its outer nacelle structure 74 may also form a radial outer peripheral boundary of the bypass flowpath 70.

During operation, ambient air from outside of the aircraft enters the aircraft propulsion system 22 and its turbine engine 24 through an airflow inlet 76. This air is directed across the propulsor section 40 and into a core flowpath 78 (e.g., annular core flowpath) and the bypass flowpath 70. The core flowpath 78 of FIG. 1 extends sequentially through the LPC section 41A, the HPC section 41B, the combustor section 42, the HPT section 43A and the LPT section 43B from an airflow inlet 80 into the core flowpath 78 to a combustion products exhaust 82 out from the core flowpath 78. The air entering the core flowpath 78 may be referred to as “core air”. The bypass flowpath 70 extends through a bypass duct, which bypass flowpath 70 and bypass duct bypass (e.g., are disposed radially outboard of and extend along) the engine core 46 and the inner housing structure 28. The air within the bypass flowpath 70 may be referred to as “bypass air”.

The core air is compressed by the LPC rotor 49 and the HPC rotor 50 and is directed into a combustion chamber 84 (e.g., an annular combustion chamber) of a combustor (e.g., an annular combustor) in the combustor section 42. Fuel is injected into the combustion chamber 84 by one or more fuel injectors and mixed with the compressed core air to provide a fuel-air mixture. This fuel-air mixture is ignited and combustion products thereof flow through and sequentially drive rotation of the HPT rotor 51 and the LPT rotor 52 about the powerplant axis 32. The rotation of the HPT rotor 51 and the LPT rotor 52 respectively drive rotation of the HPC rotor 50 and the LPC rotor 49 about the powerplant axis 32 and, thus, compression of the air received from the core inlet 80. The rotation of the LPT rotor 52 also drives rotation of the propulsor rotor 48. The rotation of the propulsor rotor 48 propels the bypass air through and out of the bypass flowpath 70. The propulsion of the bypass air may account for a majority of thrust generated by the turbine engine 24 of FIG. 1.

While the turbine engine 24 is described above with a particular two rotating structure arrangement, the present disclosure is not limited thereto. For example, the LPC rotor 49 may be omitted to configure the LPT rotor 52 as a power turbine (PT) rotor for the propulsor rotor 48. In another example, the turbine engine 24 may also include another rotating structure; e.g., an intermediate speed spool for the engine core 46.

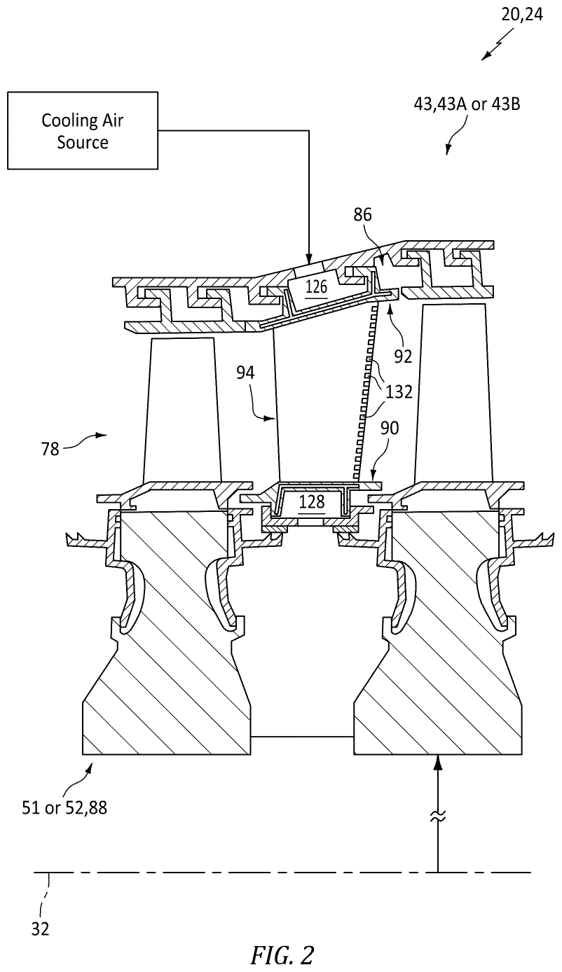

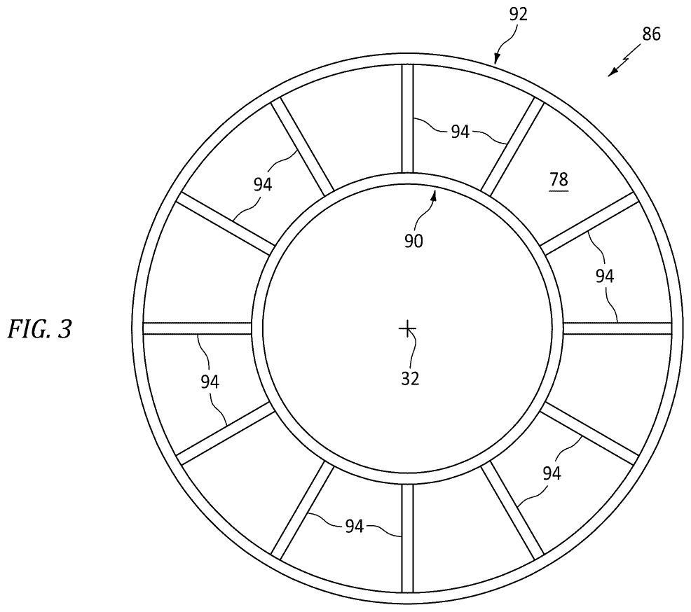

FIG. 2 illustrates an air-cooled turbine vane structure 86 (e.g., a turbine vane array) for the turbine section 43. This turbine vane structure 86 may be arranged at various locations along the core flowpath 78 within the turbine section 43. The turbine vane structure 86 of FIG. 2, for example, is arranged between a set of adjacent stages of a turbine rotor 88 along the core flowpath 78. With this arrangement, the turbine vane structure 86 may be disposed in the HPT section 43A of FIG. 1, and the turbine rotor 88 may be the HPT rotor 51. Alternatively, the turbine vane structure 86 may be disposed in the LPT section 43B of FIG. 1, and the turbine rotor 88 may be the LPT rotor 52. Still alternatively, the turbine vane structure 86 may be disposed between the HPT section 43A and the LPT section 43B of FIG. 1, where the turbine rotor stage upstream of the turbine vane structure 86 along the core flowpath 78 is part of the HPT rotor 51, and where the turbine rotor stage downstream of the turbine vane structure 86 along the core flowpath 78 is part of the LPT rotor 52. The turbine vane structure 86 of the present disclosure, however, is not limited to such exemplary arrangements. The turbine vane structure 86 of FIG. 2 includes a radial inner platform 90, a radial outer platform 92 and a plurality of stationary turbine vanes 94.

The inner platform 90 extends axially along the powerplant axis 32 from an axial upstream end of the inner platform 90 to an axial downstream end of the inner platform 90. The inner platform 90 extends radially from a radial inner side of the inner platform 90 to a radial outer side of the inner platform 90. Referring to FIG. 3, the inner platform 90 extends circumferentially about (e.g., completely around) the powerplant axis 32. The inner platform 90 of FIG. 3 may thereby be configured with a full-hoop (e.g., tubular) geometry. At the inner platform outer side of FIG. 2, the inner platform 90 forms a radial inner peripheral boundary of a longitudinal length of the core flowpath 78 which extends through the turbine vane structure 86.

The outer platform 92 is spaced radially outboard from the inner platform 90. The outer platform 92 extends axially along the powerplant axis 32 from an axial upstream end of the outer platform 92 to an axial downstream end of the outer platform 92. The outer platform 92 extends radially from a radial inner side of the outer platform 92 to a radial outer side of the outer platform 92. Referring to FIG. 3, the outer platform 92 extends circumferentially about (e.g., completely around) the powerplant axis 32. The outer platform 92 of FIG. 3 may thereby be configured with a full-hoop (e.g., tubular) geometry. At the outer platform inner side of FIG. 2, the outer platform 92 forms a radial outer peripheral boundary of the longitudinal length of the core flowpath 78 which extends through the turbine vane structure 86.

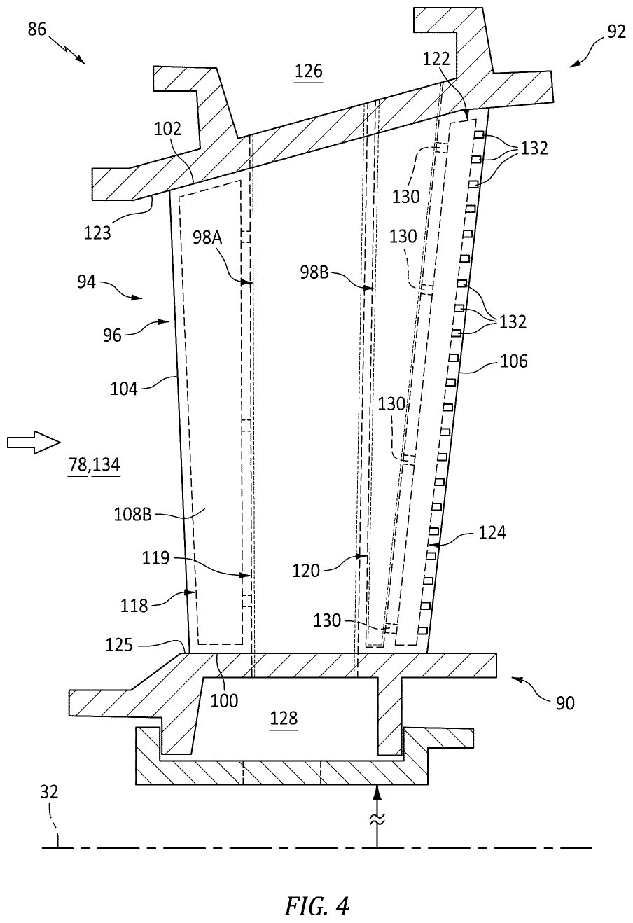

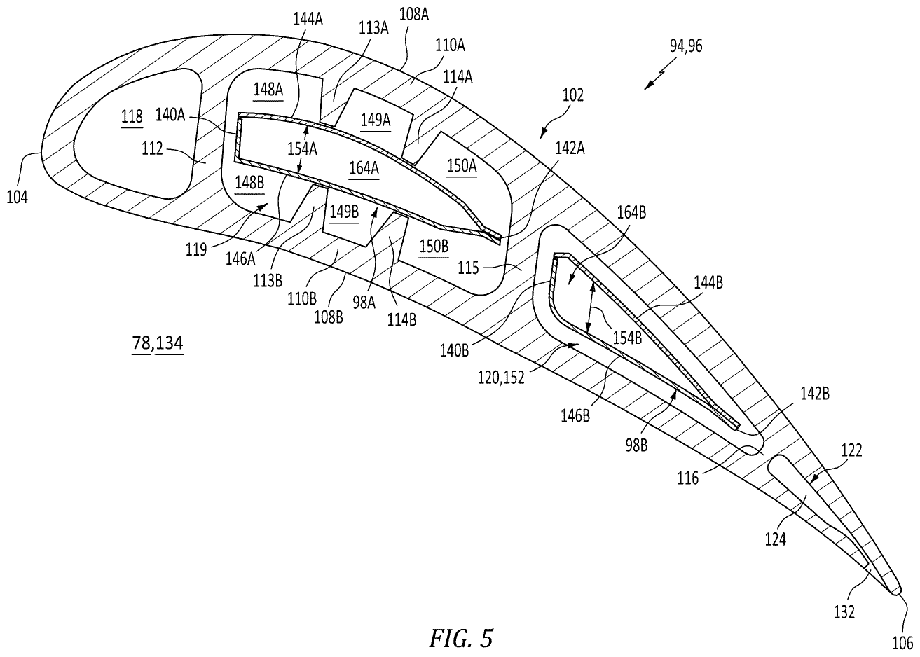

Referring to FIG. 3, the turbine vanes 94 are arranged and may be equispaced circumferentially about the powerplant axis 32 in an annular vane array. This vane array and its turbine vanes 94 are disposed radially between the inner platform 90 and the outer platform 92. Referring to FIGS. 4 and 5, each of the turbine vanes 94 includes a turbine vane airfoil 96 arranged with one or more internal baffles 98A and 98B (generally referred to as “98”).

Referring to FIG. 4, the vane airfoil 96 extends spanwise (e.g., radially relative to the powerplant axis 32) from a radial inner, base end 100 of the vane airfoil 96 to a radial outer, tip end 102 of the vane airfoil 96. The airfoil base end 100 of FIG. 4 is disposed radially adjacent the inner platform 90, and the vane airfoil 96 may be formed integral with or otherwise connected to the inner platform 90 at (e.g., on, adjacent or proximate) the airfoil base end 100. The airfoil tip end 102 of FIG. 4 is disposed radially adjacent the outer platform 92, and the vane airfoil 96 may be formed integral with or otherwise connected to the outer platform 92 at the airfoil tip end 102. The vane airfoil 96 extends longitudinally (e.g., generally axially along the powerplant axis 32) from a leading edge 104 of the vane airfoil 96 to a trailing edge 106 of the vane airfoil 96, where the airfoil leading edge 104 is upstream of the airfoil trailing edge 106 along the core flowpath 78. Referring to FIG. 5, the vane airfoil 96 extends laterally (e.g., circumferentially about the powerplant axis 32, or tangentially to a reference circle circumscribing the powerplant axis 32) between and to opposing lateral sides 108A and 108B (generally referred to as “108”) of the vane airfoil 96. The airfoil first side 108A of FIG. 5 is a convex, suction side of the vane airfoil 96. The airfoil second side 108B of FIG. 5 is a concave, pressure side of the vane airfoil 96. The opposing airfoil sides 108 extend longitudinally to and meet at the airfoil leading edge 104 and the airfoil trailing edge 106. Referring to FIGS. 4 and 5, each of the airfoil members 104, 106, 108A and 108B extends spanwise from the airfoil base end 100/the inner platform 90 to the airfoil tip end 102/the outer platform 92.

Referring to FIG. 5, the vane airfoil 96 includes a first (e.g., convex, suction) sidewall 110A, a second (e.g., concave, pressure) sidewall 110B and one or more interior walls 112-116; e.g., ribs, dividers, etc. With this arrangement, the vane airfoil 96 is configured with one or more interior volumes; e.g., cavities and/or passages. More particularly, the vane airfoil 96 of FIG. 5 is configured with a leading edge cooling passage 118, an intermediate cooling cavity 119 and a trailing edge cooling cavity 120. The vane airfoil 96 of FIG. 5 also includes a trailing edge cooling circuit 122 with a circuit cavity 124.

The airfoil first sidewall 110A forms the airfoil first side 108A. The airfoil second sidewall 110B forms the airfoil second side 108B. These airfoil sidewalls 110A and 110B (generally referred to as “110”) extend longitudinally to and meet at the airfoil leading edge 104 and the airfoil trailing edge 106. The interior walls 112-116 are arranged and spaced apart longitudinally between the airfoil leading edge 104 and the airfoil trailing edge 106. Each of the interior walls 112, 115 and 116 extends laterally between and is connected to the airfoil first sidewall 110A and the airfoil second sidewall 110B. The interior walls 112, 115 and 116 thereby divide an interior of the vane airfoil 96 of FIG. 5 into the interior volumes 118, 119, 120 and 124. Each of the first side interior walls 113A and 114A is connected to the airfoil first sidewall 110A and projects partially laterally into the intermediate cooling cavity 119. Each of the second side interior walls 113B and 114B is connected to the airfoil second sidewall 110B and projects partially laterally into the intermediate cooling cavity 119. Each second side interior wall 113B, 114B may be longitudinally aligned with a respective one of the first side interior walls 113A, 114A so as to form a channel laterally between lateral ends of the respective set of interior walls 113A and 113B (generally referred to as “113”), 114A and 114B (generally referred to as “114”) to receive the intermediate vane baffle 98A.

Each of the interior volumes 118, 119, 120 and 124 may extend laterally within the vane airfoil 96 between and to the airfoil first sidewall 110A and the airfoil second sidewall 110B. The leading edge cooling passage 118 extends longitudinally within the vane airfoil 96 from an upstream intersection between the airfoil sidewalls 110 at the airfoil leading edge 104 to the leading edge interior wall 112 (e.g., the interior wall longitudinally closest to the airfoil leading edge 104). The intermediate cooling cavity 119 extends longitudinally within the vane airfoil 96 from the leading edge interior wall 112 to the intermediate interior wall 115. The trailing edge cooling cavity 120 extends longitudinally within the vane airfoil 96 from the intermediate interior wall 115 to the trailing edge interior wall 116 (e.g., the interior wall longitudinally closest to the airfoil trailing edge 106). The circuit cavity 124 extends longitudinally within the vane airfoil 96 from the trailing edge interior wall 116 to a downstream intersection between the airfoil sidewalls 110 at the airfoil trailing edge 106.

Referring to FIG. 4, each of the interior volumes 118, 119, 120 and 124 extends spanwise in the vane airfoil 96 from (or about) a radial inner surface 123 of the outer platform 92 (e.g., at or about the airfoil tip end 102) to (or about) a radial outer surface 125 of the inner platform 90 (e.g., at or about the airfoil base end 100). Each of the interior volumes 119 and 120, for example, may project spanwise into the vane airfoil 96 from the outer platform inner surface 123 to a distal end at (or near) the inner platform outer surface 125. The interior volumes 119 and 120 (e.g., cooling passages) also are projected radially through the outer platform 92 so as to be fluidly coupled with an outer plenum 126 radially adjacent and outboard of the outer platform 92. In addition, the intermediate interior cavity 119 is also fluidly coupled with an inner plenum 128 through one or more ports in the inner platform 90, which inner plenum 128 may be radially adjacent and inboard of the inner platform 90. Alternatively, the intermediate interior cavity 119 may project radially through the inner platform 90 to the inner plenum 128. The trailing edge cooling cavity 120 of FIG. 4, by contrast, is fluidly separated and decoupled from the inner plenum 128 by the inner platform 90. In addition, the circuit cavity 124 of FIG. 4 extends spanwise within (e.g., not into or through) the vane airfoil 96. This circuit cavity 124 is thereby fluidly separated and decoupled from the outer plenum 126 by the outer platform 92. The circuit cavity 124 is also fluidly separated and decoupled from the inner plenum 128 by the inner platform 90.

While interior walls 113A, 113B, 114A, and 114B (e.g., partial rib standoff features) are illustratively shown in FIG. 4 to have a comparable height (H1, H2, H3, H4) and a comparable width (W1, W2 W3, W4), the heights H and the widths W may vary in the spanwise direction to optimize internal cooling characteristics, convective heat transfer, pressure loss, and/or cooling air heat pickup. In addition or alternatively, the interior walls 113A, 113B, 114A, and 114B (e.g., the partial rib standoff features) may be linear or curvilinear in shape to provide structural support of airfoil exterior walls 110A and 110B, as well as supporting the first side of the interior baffle surface 144A and the second side of the interior baffle surface 146A, respectively.

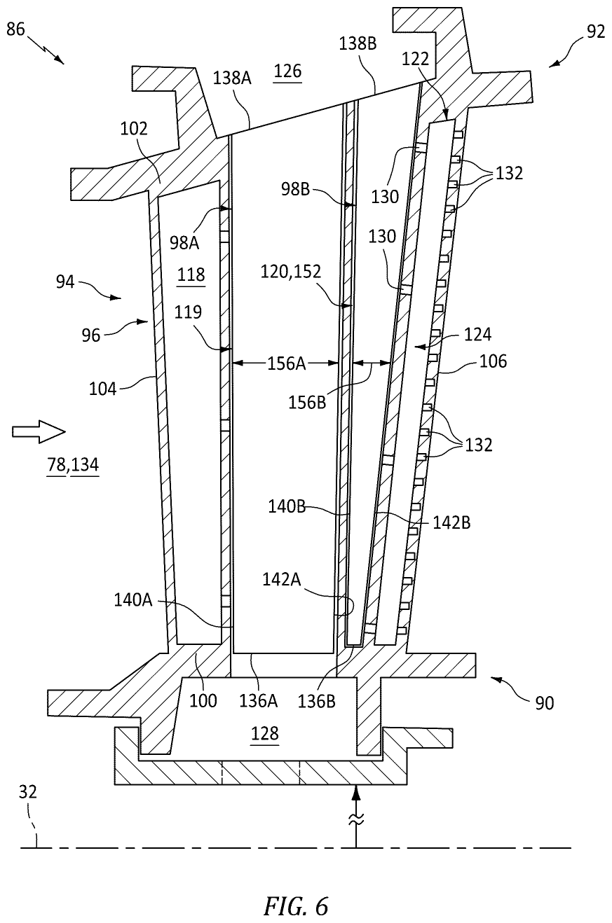

Referring to FIG. 6, the trailing edge cooling circuit 122 includes the circuit cavity 124, one or more flow circuit bleed flow apertures 130 (e.g., inlets) and one or more circuit outlets 132 (e.g., cooling apertures). The circuit bleed flow apertures 130 are arranged and may be uniformly and/or nonuniformly distributed and vary in cross sectional area in the spanwise direction along the trailing edge interior wall 116. Each of these circuit bleed flow apertures 130 may be a port which projects longitudinally through the trailing edge interior wall 116 from the circuit cavity 124 to the trailing edge cooling cavity 120. The circuit bleed flow apertures 130 thereby fluidly couple the trailing edge cooling cavity 120 to the circuit cavity 124. The circuit outlets 132 are arranged at, along and may (or may not) be equispaced spanwise along the airfoil trailing edge 106. Each of the circuit outlets 132 may be a port which projects through a respective sidewall 110 (e.g., 110B of FIG. 4) of the vane airfoil 96 from the circuit cavity 124 to an environment 134 external to the vane airfoil 96—the core flowpath 78. Each circuit outlet 132 of FIG. 5 is disposed in the airfoil second side 108B, longitudinally adjacent the airfoil trailing edge 106. It is contemplated, however, one or more of the circuit outlets 132 may alternatively be disposed in the airfoil trailing edge 106.

Referring again to FIG. 6, each of the vane baffles 98A, 98B is disposed (e.g., partially or completely) within a respective one of the interior volumes 119, 120. Each of these vane baffles 98A, 98B extends spanwise (e.g., radially relative to the powerplant axis 32) from a radial ID inner, base end 136A, 136B (generally referred to as “136”) of the respective vane baffle 98A, 98B to a radial outer, OD end 138A, 138B (generally referred to as “138”) of the respective vane baffle 98A, 98B. Each baffle base end 136 of FIG. 6 is disposed at (or near) the inner platform outer surface 125. Each OD baffle end 138 of FIG. 6 is disposed at (or near) the outer platform inner surface 123. Each vane baffle 98A, 98B extends in a predominately axial chordwise direction (e.g., generally axially along the powerplant axis 32) from an upstream end 140A, 140B (generally referred to as “140”) of the respective vane baffle 98A, 98B to a trailing edge 142A, 142B (generally referred to as “142”) of the respective vane baffle 98A, 98B, where the baffle end 140 is upstream of the baffle trailing edge 142 along the axial core flow path direction 78. Referring to FIG. 5, each vane baffle 98A, 98B extends laterally in a predominately axial chordwise direction between and to opposing lateral sides 144A, 144B (generally referred to as “144”) and 146A, 146B (generally referred to as “146”) of the respective vane baffle 98A, 98B. Each baffle first side 144 of FIG. 5 is laterally next to the airfoil first sidewall 110A. Each baffle second side 146 of FIG. 5 is laterally next to the airfoil second sidewall 110B. The opposing baffle sides 144 and 146 project longitudinally out from the respective baffle end 140 to and meet at the respective baffle trailing edge 142. Referring to FIGS. 5 and 6, each member 140, 142, 144, 146 of a respective vane baffle 98 extends spanwise from the respective ID baffle end 136, to the respective OD baffle end 138. With this arrangement, referring to FIG. 5, one or more first side cooling passages 148A-150A are formed by and laterally between the airfoil first sidewall 110A and the intermediate baffle first side 144A. One or more second side cooling passages 148B-150B are formed by and laterally between the airfoil second sidewall 110B and the intermediate baffle second side 146A. Similarly, a first portion of a trailing edge cooling passage 152 is formed by and laterally between the airfoil first sidewall 110A and the trailing edge baffle first side 144B. A second portion of the trailing edge cooling passage 152 is formed by and laterally between the airfoil second sidewall 110B and the trailing edge baffle second side 146B.

Each vane baffle 98A, 98B of FIG. 6 has a longitudinal width 156A, 156B (generally referred to as “156”) extending from the respective baffle end 140 to the respective baffle trailing edge 142. This baffle longitudinal width (height) 156 may (e.g., continuously and/or uniformly) decreases in a longitudinal (predominately in a radially oriented) direction as the respective vane baffle 98 extends spanwise from (or about) the respective OD baffle end 138 to (or about) the respective ID baffle end 136. Referring to FIG. 5, each vane baffle 98A, 98B has a lateral width 154A, 154B (generally referred to as “154”) extending between its opposing baffle sides 144 and 146. This baffle lateral width 154 may change (e.g., increase and then decrease, decrease, etc.) as the respective vane baffle 98 extends longitudinally from (or about) the respective baffle end 140 to (or about) the respective baffle trailing edge 142.

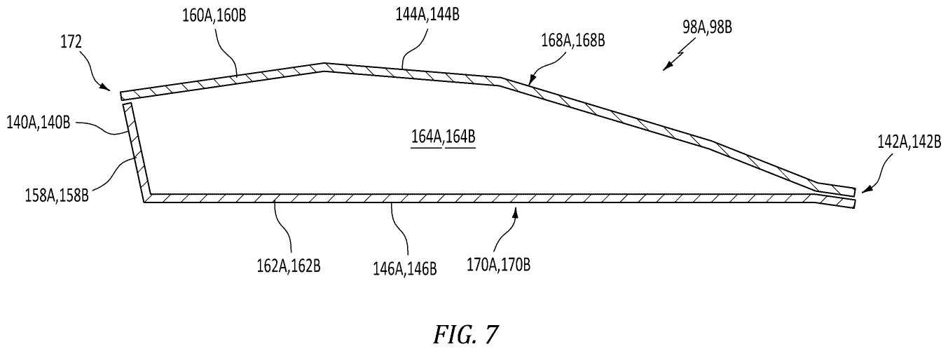

Referring to FIG. 7, each vane baffle 98A, 98B depicted in FIG. 6 includes a leading, forward, and/or upstream sidewall 158A, 158B (generally referred to as “158”), a first (e.g., suction side) sidewall 160A, 160B (generally referred to as “160”) and a second (e.g., pressure side) sidewall 162A, 162B (generally referred to as “162”). The vane baffle 98A, 98B also includes an interior cavity 164A, 164B (generally referred to as “164”). Note, while FIG. 7 is shown with a certain cross-sectional geometry for ease of illustration, the vane baffles 98 of the present disclosure are not limited thereto.

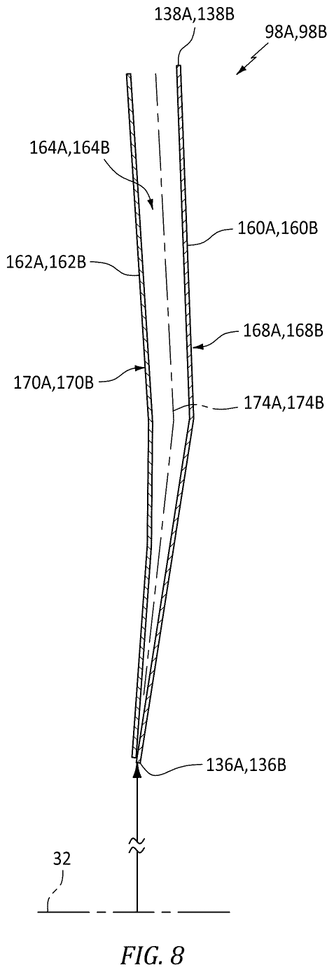

The baffle upstream sidewall 158 forms the respective baffle end 140 and may be positioned on either the forward side (the leading side) or the aft side (the trailing side) of the vane baffle 98A, 98B. The baffle upstream sidewall 158 extends laterally, in a direction extending toward the airfoil first sidewall 110A which forms the airfoil first side 108A and the airfoil second sidewall 110B which forms the airfoil second side 108B (see FIG. 5), along a (e.g., entire) lateral width (height) of the respective baffle cavity 164, between and to the respective baffle first sidewall 160 and the respective baffle second sidewall 162. The respective baffle first sidewall 160 forms the respective baffle first side 144. The respective baffle second sidewall 162 forms the respective baffle second side 146. Each of these baffle sidewalls 160 and 162 projects longitudinally, along a (e.g., entire) longitudinal length (predominately along an axial length or chordwise distance) of the respective baffle cavity 164, out from the respective baffle upstream sidewall 158 to and meet at (or about) the respective baffle trailing edge 142. Referring to FIG. 8, each of the baffle sidewalls 160 and 162 also projects spanwise, along a (e.g., entire) spanwise length (predominately in a radial direction/orientation) of the respective baffle cavity 164, from the respective baffle OD end 138 to and meet at (or about) the respective baffle ID end 136.

Referring to FIG. 7, each vane baffle 98 may be configured with a multi-section construction. The baffle first sidewall 160 of FIG. 7, for example, is (e.g., completely) formed from a first sheet of metal 168A, 168B (generally referred to as “168”); e.g., cut and shaped sheet metal. The baffle upstream wall 158 and the baffle second sidewall 162 of FIG. 7 are (e.g., completely) formed from a second sheet of metal 170A, 170B (generally referred to as “170”); e.g., cut and shaped sheet metal.

The baffle first sidewall 160/the first sheet of metal 168 of FIG. 7 is bonded (e.g., welded) to the baffle second sidewall 162/the second sheet of metal 170 at an interface between the baffle first sidewall 160 and the baffle second sidewall 162 at the baffle trailing edge 142. For example, at the baffle trailing edge 142 of FIG. 7, a trailing edge portion of the baffle first sidewall 160 may extend longitudinally along in a predominately spanwise or radial direction and may extend laterally abut against and contact a trailing edge portion of the baffle second sidewall 162. These two abutted trailing edge portions may be bonded along an exterior seam between the baffle first sidewall 160 and the baffle second sidewall 162 on the baffle trailing edge 142. Here, the first sheet of metal 168 of FIG. 7 is bonded to the second sheet of metal 170 through a lap joint.

The baffle first sidewall 160/the first sheet of metal 168 of FIG. 7 is bonded (e.g., welded) to the baffle upstream sidewall 158/the second sheet of metal 170 at a corner 172 between the baffle first sidewall 160 and the baffle upstream endwall 158. Here, the first sheet of metal 168 of FIG. 7 is bonded to the second sheet of metal 170 through a butt joint.

The baffle first sidewall 160/the first sheet of metal 168 of FIG. 8 is also bonded (e.g., welded) to the baffle second sidewall 162/the second sheet of metal 170 at an interface between the baffle first sidewall 160 and the baffle second sidewall 162 at the ID baffle end 136. For example, at the baffle ID end 136, the baffle first sidewall 160 and the baffle second sidewall 162 may converge to a point where those two abutted sidewalls 160 and 162 may be bonded along an exterior seam on the baffle base end 136.

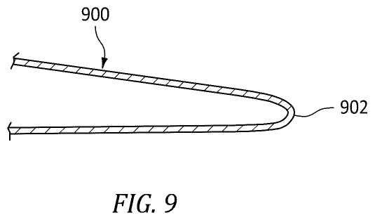

With the foregoing construction, the vane baffle 98 of FIG. 7 may be configured with a smaller lateral width at the baffle trailing edge 142 (and the baffle ID end 136 of FIG. 8) compared to a construction where a single sheet of metal 900 is bent to form an edge 902; e.g., see FIG. 9. The vane baffle 98 of FIG. 7 may thereby be extended further into relatively small areas (e.g., converging cooling sidewalls and baffle passages extending in either predominately axially and/or radially extending directions, crevices, openings, corners, etc.) of the vane airfoil. In addition, by forming the vane baffle 98 of FIG. 8 out of the multiple different sheets of metal, the vane baffle 98 may be provided with a geometry which may not otherwise be feasible by forming a baffle from a single sheet of metal around a mandrel. At least a portion of a spanwise extending centerline 174A, 174B of the vane baffle 98 and its baffle cavity 164 of FIG. 8, for example, may be non-linear (e.g., curved, angled, have variation or reversal in curvature, etc.) in such a fashion that a forming mandrel could not be readily removed. The vane baffles 98 of the present disclosure therefore may be disposed in relatively small vane airfoils and tailored to provide more uniform cooling within the vane airfoils.

Referring to FIG. 7, each baffle cavity 164 extends longitudinally in a predominately radial direction within the respective vane baffle 98 and from the respective baffle upstream sidewall 158 to the interface between the opposing baffle sidewalls 160 and 162 at the respective baffle trailing edge 142. The baffle cavity 164 of FIG. 7 extends laterally within the vane baffle 98 between the opposing baffle sidewalls 160 and 162. The baffle cavity 164 of FIG. 8 extends spanwise partially into the vane baffle 98 from the baffle OD end 138 to the baffle ID end 136. Referring to FIG. 5, each baffle cavity 164A, 164B may be fluidly decoupled from each of the cooling passages 148A-150B, 152 adjacent and outside of the respective vane baffle 98.

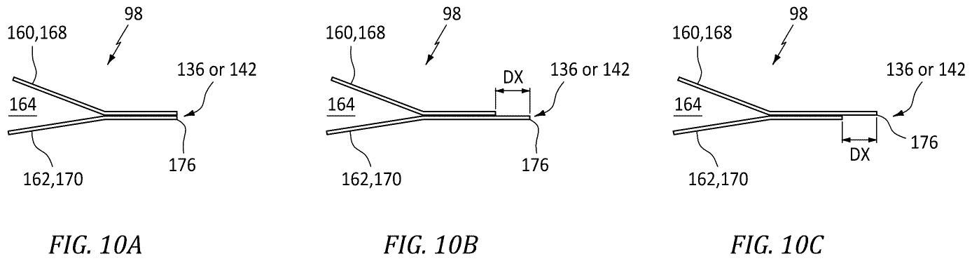

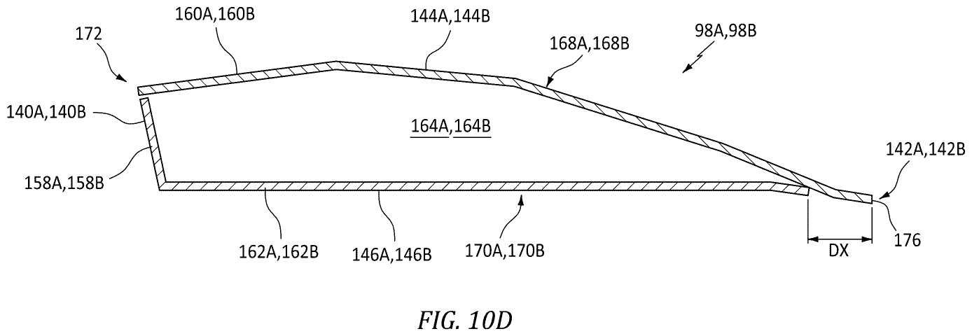

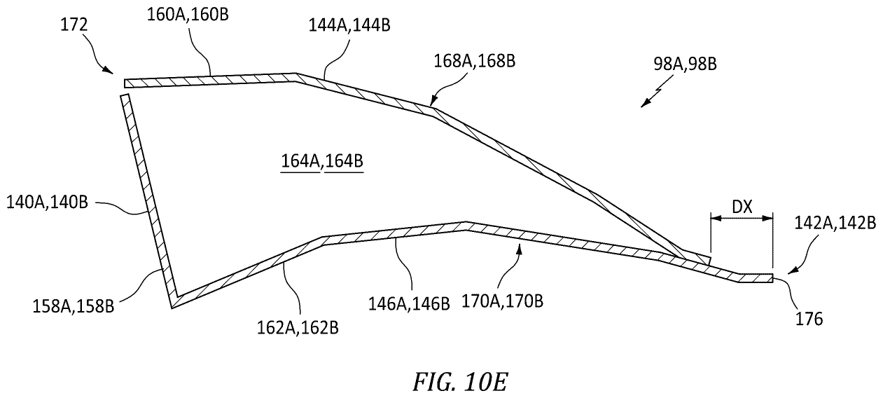

In some embodiments, referring to FIG. 10A, (a) the baffle first sidewall 160/the first sheet of metal 168 and (b) the baffle second sidewall 162/the second sheet of metal 170 may each extend (e.g., longitudinally or spanwise) to a respective common end 176 of the respective vane baffle 98; e.g., the baffle trailing edge 142 or the baffle ID end 136. With such an arrangement, an edge of the baffle first sidewall 160/the first sheet of metal 168 and an edge of the baffle second sidewall 162/the second sheet of metal 170 at the respective baffle end 176 are (e.g., longitudinally or spanwise) aligned. In other embodiments, referring to FIGS. 10B and 10C, the edge of the baffle first sidewall 160/the first sheet of metal 168 and the edge of the baffle second sidewall 162/the second sheet of metal 170 may be offset a distance “DX” (e.g., longitudinally, axially) either along a portion of, or along the entire spanwise length) of the two adjoining first and second sidewalls 160, and 162, at the respective trailing end (e.g., rearward, aft, and/or downstream side) of the baffle 98, at a location approximate the trailing baffle surface end 176. Other examples of such an offset are shown in FIGS. 10D and 10E.

Referring to FIG. 10B, the edge of the baffle first sidewall 160/the first sheet of metal 168 is (e.g., longitudinally or spanwise) recessed inward (forward) a distance “DX” from the baffle second sidewall 162/the second sheet of metal 170. In another example, referring to FIG. 10C, the edge of the baffle second sidewall 162/the second sheet of metal 170 is (e.g., longitudinally or spanwise) recessed inward (forward) a distance “DX” from the baffle first sidewall 160/the first sheet of metal 168. The offset “DX” may be a constant offset value or may vary either linearly or nonlinearly along the spanwise length of baffle 98. Although not depicted, the baffle end 176 of baffle 98 may be linear, comprise of multiple linear segment sectors, or form a continuous curved edge, to ensure an optimal offset is maintained relative to nonlinear or curved internal vane airfoil ribs 112, 115 and 116, or trailing edge flow apertures 130 in FIG. 6.

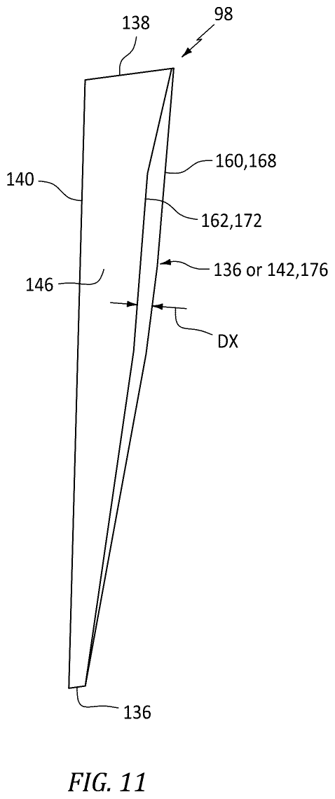

The baffle sidewalls 146, and 148 and the baffle end 176 may be bowed in predominately an axial direction, and/or bowed in a circumferential or tangential direction) to maintain an optimal offset from bowed airfoil walls 110. With the arrangements of FIGS. 10B and 10C, referring to FIG. 11, a geometry of the baffle first sidewall 160/the first sheet of metal 168 may be different than a geometry of the baffle second sidewall 162/the second sheet of metal 170 to tailor, for example, a thickness of the respective vane baffle 98 at the respective trailing, rearward, aft, and/or downstream side of the baffle 98, located approximate the trailing baffle surface end 176.

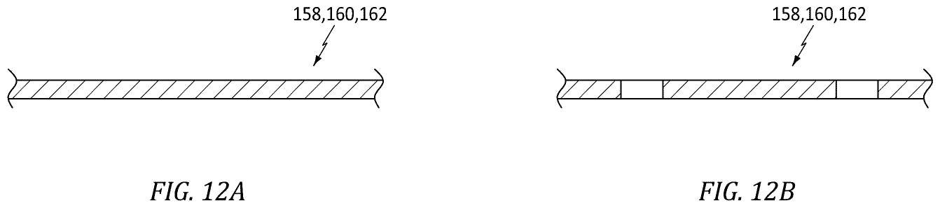

In some embodiments, referring to FIG. 12A, each baffle member 158, 160, 162 may be non-porous; e.g., non-perforated. Each baffle member 158, 160, 162 of FIG. 12A, for example, extends along the respective baffle cavity 164 without any interruptions; e.g., longitudinal or lateral interruptions, spanwise interruptions. Each baffle member 158, 160, 162 of FIG. 12A may thereby completely fluidly separate the respective baffle cavity from the exterior cooling passage(s). In other embodiments, referring to FIG. 12B, any one, some or all of the baffle members 158, 160, 162 may be perforated to facilitate and control cooling air fluid flow across the respective baffle member 158, 160, 162 to optimize internal convective heat transfer, pressure loss, and/or cooling air temperature heat pickup. The quantity, size, shape, spacing, and/or location of the flow apertures within baffle members 158, 160, 162 may be tailored independently to maximize both local and macro thermal cooling effectiveness requirements to achieve thermal-mechanical durability life requirements of the hot section component.

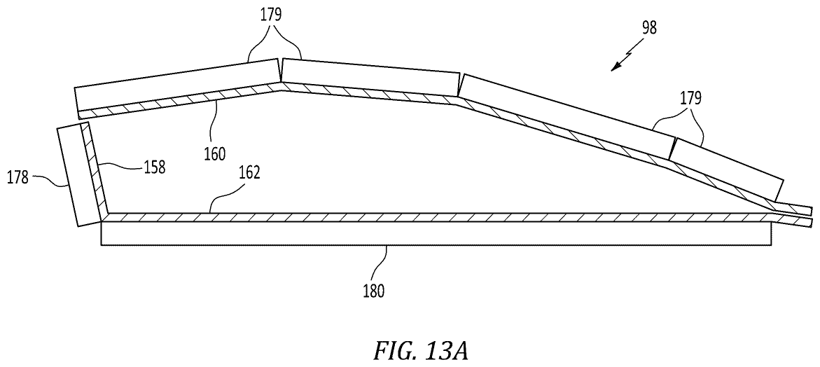

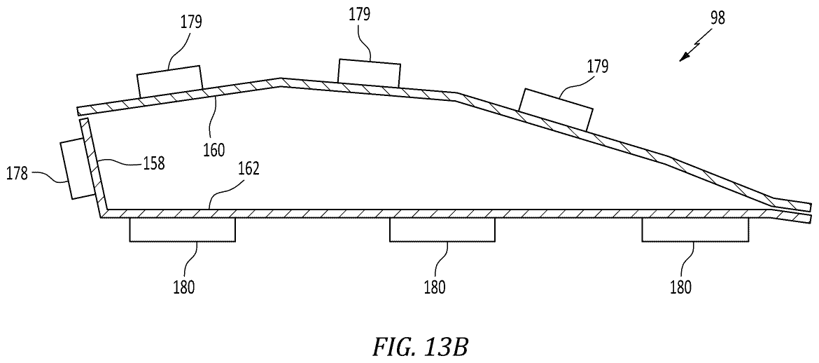

In some embodiments, referring to FIGS. 13A and 13B, each vane baffle 98 may be configured with one or more mounting flanges 178-180. Each flange 178-180 may be connected to (e.g., formed integral with or otherwise attached to) a respective one of the baffle members 158, 160, 162. Each flange 178-180 may project (e.g., laterally or longitudinally) out from the baffle members 158, 160, 162. With this configuration, the flange(s) 178-180 may be used for spanwise locating the respective vane baffle 98 relative to the vane airfoil 96.

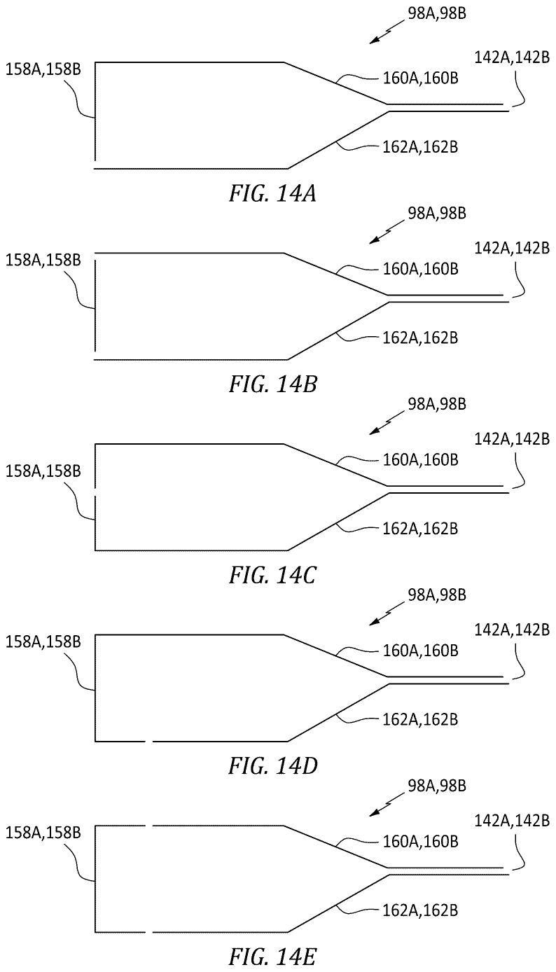

While the vane baffle 98 is shown with a certain segmented construction in FIG. 7, the present disclosure is not limited thereto. The vane baffle 98, for example, may alternatively be provided with one of the segmented constructions shown in FIGS. 14A-E.

While various embodiments of the present disclosure have been described, it will be apparent to those of ordinary skill in the art that many more embodiments and implementations are possible within the scope of the disclosure. For example, the present disclosure as described herein includes several aspects and embodiments that include particular features. Although these features may be described individually, it is within the scope of the present disclosure that some or all of these features may be combined with any one of the aspects and remain within the scope of the disclosure. Accordingly, the present disclosure is not to be restricted except in light of the attached claims and their equivalents.

What is claimed is:

1. An assembly for a turbine engine, comprising:
an airfoil extending spanwise from an airfoil base end to an airfoil tip end, the airfoil extending longitudinally from an airfoil leading edge to an airfoil trailing edge, the airfoil extending laterally between an airfoil first side and an airfoil second side with the airfoil second side meeting the airfoil first side at the airfoil leading edge and the airfoil trailing edge, and an airfoil cavity projecting spanwise into the airfoil from the airfoil tip end towards the airfoil base end; and
a baffle disposed in the airfoil cavity with an outer passage formed between the baffle and a wall of the airfoil, the baffle extending longitudinally from a baffle end to a baffle trailing edge, the baffle extending laterally between a baffle first side and a baffle second side with the baffle second side meeting the baffle first side at the baffle trailing edge, the baffle including an endwall, a first sidewall, a second sidewall and a baffle cavity, the endwall forming the baffle end laterally along the baffle cavity, the first sidewall forming the baffle first side longitudinally along the baffle cavity, the second sidewall forming the baffle second side longitudinally along the baffle cavity, and the second sidewall bonded to the first sidewall at the baffle trailing edge.

2. The assembly of claim 1, wherein the baffle cavity extends laterally within the baffle from the first sidewall to the second sidewall, and the baffle cavity extends longitudinally within the baffle from the endwall to a lateral interface between the first sidewall and the second sidewall at the baffle trailing edge.

3. The assembly of claim 2, wherein at least one of
the first sidewall extends longitudinally uninterrupted along the baffle cavity from the endwall to the lateral interface; or
the second sidewall extends longitudinally uninterrupted along the baffle cavity from the endwall to the lateral interface.

4. The assembly of claim 1, wherein the baffle extends spanwise from a baffle base end disposed at the airfoil base end to a baffle tip end disposed at the airfoil tip end, and the baffle cavity is closed at the baffle base end.

5. The assembly of claim 1, wherein the baffle extends spanwise from a baffle base to a baffle tip, and the second sidewall is bonded to the first sidewall at the baffle trailing edge spanwise along the baffle trailing edge from the baffle base to the baffle tip.

6. The assembly of claim 1, wherein, at the baffle trailing edge, the first sidewall extends longitudinally along and is abutted laterally against the second sidewall.

7. The assembly of claim 1, wherein the first sidewall and the second sidewall extend longitudinally to a common location at the baffle trailing edge.

8. The assembly of claim 1, wherein an edge of the first sidewall is longitudinally recessed from an edge of the second sidewall at the baffle trailing edge.

9. The assembly of claim 1, wherein the first sidewall is welded to the second sidewall at the baffle trailing edge.

10. The assembly of claim 1, wherein
the first sidewall is formed by a first sheet of metal;
the endwall and the second sidewall are formed by a second sheet of metal; and
the first sheet of metal is bonded to the second sheet of metal at the baffle trailing edge.

11. The assembly of claim 10, wherein the first sheet of metal is further bonded to the second sheet of metal at a corner between the endwall and the first sidewall.

12. The assembly of claim 10, wherein
the airfoil first side is a suction side of the airfoil, and the baffle first side is disposed laterally between the baffle second side and the airfoil first side; and
the airfoil second side is a pressure side of the airfoil, and the baffle second side is disposed laterally between the baffle first side and the airfoil second side.

13. The assembly of claim 10, wherein
the airfoil first side is a convex side of the airfoil, and the baffle first side is disposed laterally between the baffle second side and the airfoil first side; and
the airfoil second side is a concave side of the airfoil, and the baffle second side is disposed laterally between the baffle first side and the airfoil second side.

14. The assembly of claim 1, wherein
the baffle extends spanwise from a baffle base end to a baffle tip end;
the baffle further includes a flange at the baffle tip end; and
the flange projects laterally out from one of the endwall, the first sidewall or the second sidewall.

15. The assembly of claim 1, wherein
the baffle extends spanwise from a baffle base end to a baffle tip end; and
at least a portion of a centerline of the baffle cavity that extends spanwise from the baffle base end to the baffle tip end is non-linear.

16. The assembly of claim 1, further comprising a turbine vane structure including the airfoil and the baffle.

17. The assembly of claim 1, further comprising:
an inner platform extending circumferentially around a centerline;
an outer platform extending circumferentially around the centerline; and
a plurality of vanes arranged circumferentially around the centerline in an array, each of the plurality of vanes extending spanwise from the inner platform to the outer platform, and a first of the plurality of vanes comprising at least the airfoil.

18. An assembly for a turbine engine, comprising:
at least one airfoil extending spanwise from an airfoil base end to an airfoil tip end, the airfoil extending longitudinally from an airfoil leading edge to an airfoil trailing edge, the airfoil extending laterally between an airfoil first side and an airfoil second side with the airfoil second side meeting the airfoil first side at the airfoil leading edge and the airfoil trailing edge, and an airfoil cavity projecting spanwise into the airfoil from the airfoil tip end towards the airfoil base end; and
a baffle disposed in the airfoil cavity with a passage formed between the baffle and a wall of the airfoil, the baffle extending longitudinally from a baffle end to a baffle trailing edge, the baffle extending laterally between a baffle first side and a baffle second side with the baffle second side meeting the baffle first side at the baffle trailing edge, the baffle extending spanwise from a baffle base end to a baffle tip end, the baffle including a first sidewall, a second sidewall and a baffle cavity, the first sidewall forming the baffle first side longitudinally along the baffle cavity, the second sidewall forming the baffle second side longitudinally along the baffle cavity, the first sidewall meeting the second sidewall at an interface spanwise along the baffle trailing edge, the first sidewall longitudinally overlapping and laterally abutting against the second sidewall at the interface, and the first sidewall bonded to the second sidewall at the interface.

19. The assembly of claim 18, wherein
the baffle further includes an endwall forming the baffle end laterally along the baffle cavity; and
the first sidewall is bonded to the endwall at a corner between the baffle end and the baffle first side.

20. An assembly for a turbine engine, comprising:
at least one airfoil extending spanwise from an airfoil base end to an airfoil tip end, the airfoil extending longitudinally from an airfoil leading edge to an airfoil trailing edge, the airfoil extending laterally between an airfoil first side and an airfoil second side with the airfoil second side meeting the airfoil first side at the airfoil leading edge and the airfoil trailing edge, and an airfoil cavity projecting spanwise into the airfoil from the airfoil tip end towards the airfoil base end; and
a baffle disposed in the airfoil cavity with a passage formed between the baffle and a wall of the airfoil, the baffle extending longitudinally from a baffle end to a baffle trailing edge, the baffle extending laterally between a baffle first side and a baffle second side with the baffle second side meeting the baffle first side at the baffle trailing edge, the baffle including an endwall, a first sidewall, a second sidewall and a baffle cavity, the endwall forming the baffle end laterally along the baffle cavity, the first sidewall forming the baffle first side longitudinally along the baffle cavity, and the second sidewall forming the baffle second side longitudinally along the baffle cavity, wherein the first sidewall is bonded to the endwall at a corner between the baffle end and the baffle first side.
